(19) United States
(12) Patent Application Publication
(10) Pub. No.: US 2026/0141214 A1
(43) Pub. Date: May 21, 2026

(54) DUAL ENCODER GNNS FOR ENHANCED ENTITY RESOLUTION

(71) Applicant: Dell Products L.P., Round Rock, TX (US)

(72) Inventors: Zijia Wang, London (GB); Mustafa Al-Bado, Cork (IE); Ibrahim Abu Alhaol, Nepean (CA)

(21) Appl. No.: 18/955,865

(22) Filed: Nov. 21, 2024

(51) Int. Cl. G06N 3/042

(52) U.S. Cl. CPC G06N 3/042

(57) ABSTRACT

One example method is for improving resolution of entities represented by nodes of a graph, and includes receiving, by a dual-encoder module, local node features of nodes of a graph that comprises data, and global structure information of the graph, performing, by a local feature encoder of the dual-encoder module, a feature transformation process on the local node features, performing, by a global context encoder of the dual-encoder module, a context aggregation process on the global graph structure information, and fusing an output of the feature transformation process with an output of the global context aggregation process to generate a composite entity representation of the graph.

### TECHNOLOGICAL FIELD OF THE DISCLOSURE

Embodiments disclosed herein generally relate to processing of data that is in graph form. More particularly, at least some embodiments relate to systems, hardware, software, computer-readable media, and methods, for enhanced entity resolution in graph data.

### BACKGROUND

In the era of so-called big data, traditional methods of entity resolution struggle to cope with the volume, velocity, and variety of information, often resulting in inefficient data management and duplicate records. This is particularly true with regard to data that is represented by nodes and edges in graphs, where the nodes represent various entities, and edges connecting the nodes represent relationships between the connected nodes or entities.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an architecture, according to one embodiment.

FIG. 2 discloses aspects of a method and architecture for entity resolution in graph data, according to one embodiment.

FIG. 3 discloses an example dual-encoder architecture, according to one embodiment.

FIG. 4 discloses a computing entity configured and operable to perform any of the disclosed methods, processes, and operations.

### DETAILED DESCRIPTION OF SOME EXAMPLE EMBODIMENTS

Embodiments disclosed herein generally relate to processing of data that is in graph form. More particularly, at least some embodiments relate to systems, hardware, software, computer-readable media, and methods, for enhanced entity resolution in graph data.

One or more embodiments comprise methods and architectures for entity resolution in the context of graph data. A method according to one example embodiment may operate to improve and enhance entity resolution across a large-scale database of graph data, so as to implement more refined differentiation between similar entities, and thereby improve data management capabilities.

One method according to an example embodiment may comprise various operations including: using a dual-encoder GNN to process individual data points of a graph, and also to process aggregated information from neighboring nodes, of a node of interest, in the graph; implementing a semantic clustering to group nodes of the graph based on their semantic similarity; and, using additional layers of the dual-encoder GNN to learn higher-order interactions between the nodes of the graph.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect an embodiment is that an embodiment may provide improved, relative to conventional approaches, feature extraction concerning nodes in graph data. An embodiment may provide improved, relative to conventional approaches, entity resolution in graph data. An embodiment may operate to detect duplicate information in graph data. An embodiment may manage and resolve entities across large datasets, which may take the form of graph data, without compromising performance. An embodiment may help to avoid cascading effects of errors in applications downstream of a graph database. Various other advantages of one or more embodiments will be apparent from this disclosure.

### A. References

Reference is made herein to the documents listed below. These are all incorporated herein in their respective entireties by this reference.
[1] Franco Scarselli et al. “Graph neural networks”. In: IEEE Transactions on Neural Networks 20.1 (2009), pp. 61-80.
[2] Thomas N. Kipf and Max Welling. “Semi-supervised classification with graph convolutional networks”. In: ICLR (2017).
[3] Ryan Kiros et al. “Skip-thought vectors”. In: NIPS (2015).
[4] Huibing Wang et al. “Semantic clustering in graph neural networks”. In: ICML (2019).
[5] Qimai Li, Zhichao Han, and Xiao-Ming Wu. “Deeper insights into graph convolutional networks for semi-supervised learning”. In: AAAI Conference on Artificial Intelligence (2018).

### B. Aspects of an Example Context for One or More Embodiments

The following is a discussion of aspects of an example context for various embodiments. This discussion is not intended to limit the scope of the claims or this disclosure, or the applicability of the embodiments, in any way.

The challenges faced in the realm of entity resolution within large-scale databases are multifaceted, primarily stemming from the sheer volume, velocity, and variety of data. As such, one or more embodiments may be concerned with a variety of circumstances and constraints presently known to exist.

For example, an embodiment may provided scalability, as the exponential growth of data necessitates scalable solutions that can efficiently manage and resolve entities across large datasets without compromising performance. As another example, and in view of the complexity of data types and sources, an embodiment may provide high accuracy in duplicate detection and entity resolution so as to avoid the cascading effects of errors in downstream applications. Further, an embodiment may provide real-time processing to deal with the dynamic nature of data so as to ensure that data remains current and relevant. Further, in contrast with conventional methods that often fall short in handling complex data patterns and relationships, an embodiment may provide for accurate entity resolution. These challenges thus underscore the need for an advanced approach, implemented by one or more embodiments, that leverages the latest in graph neural networks and machine learning techniques to enhance entity resolution processes.

### C. Overview of Aspects of One or More Embodiments

In the field of entity resolution and graph-based data management, several notable approaches have been proposed. Following is a brief overview.

### C.1 Graph Neural Networks (GNNs)

GNNs have gained prominence due to their ability to process graph-structured data, that is, data that is in graph form, where a graph may include nodes that represent entities, and may also include edges that connect nodes, where the edges represent a relation between connected nodes. GNNs operate by iteratively aggregating information from neighboring nodes, enabling effective representation learning. See [1] and [2]. Graph Convolutional Networks (GCNs) may be used to generalize convolutional layers to graphs. GCNs have been widely adopted for node classification and link prediction tasks.

### C.2 Dual-Encoder Architectures

One or more example embodiments comprise, and leverage, a dual-encoder architecture, combining local node features with global graph context. This approach has been successful in various domains, including natural language processing and recommendation systems. For work in the specific domain of sentences, see [3].

### C.3 Semantic Clustering

Semantic clustering enhances graph structure by grouping similar entities. See, e.g., [4]. By incorporating semantic similarities, a graph becomes more informative, leading to improved entity recognition. One embodiment improves upon this idea, integrating semantic clustering as a preprocessing step.

### C.4 Deep Network Layers

Deeper network layers capture intricate patterns and relationships. Recent studies have explored the impact of depth in GNNs. Increasing the depth of GNNs improves performance on node classification tasks. See [5]. One embodiment extends this concept to entity resolution, providing a more refined differentiation between similar entities.

### C.5 Conclusion

An embodiment combines dual-encoder architectures, semantic clustering, and deep network layers to enhance entity resolution within large-scale databases. This approach represents a significant advancement in data management capabilities.

### D. Detailed Discussion of Aspects of One or More Embodiments

### D.1 Introduction

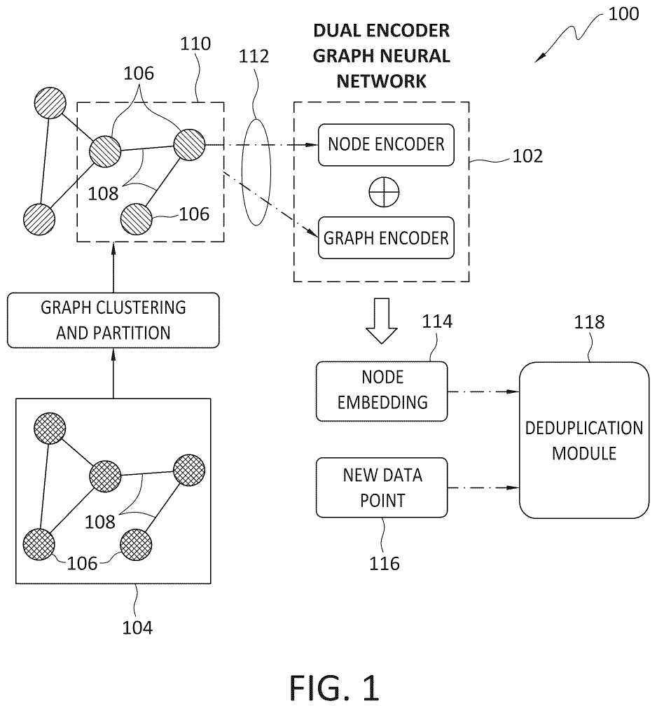

In the era of big data, traditional methods of entity resolution struggle to cope with the volume, velocity, and variety of information, often resulting in inefficient data management and duplicate records. As shown in the example architecture 100 of FIG. 1, an embodiment may overcome these challenges through the use of a dual-encoder Graph Neural Network (GNN) 102 framework for enhanced entity resolution within large-scale databases. This approach not only streamlines data consolidation but also significantly improves the accuracy of duplicate detection.

As shown in the example of FIG. 1, a graph 104 may be defined that includes various nodes 106 connected by edges 108. A graph clustering and partition process may be performed to cluster certain of the nodes 106 together, based on common attributes for example, to define a cluster 110. Notwithstanding this clustering, there may be a need for additional refinement of, that is, resolution, of the various nodes 108. Thus, the cluster 110 may be provided as an input 112 to the GNN 102 according to one embodiment. The operation of the GNN 102 may comprise a node embedding process 114 in which the GNN 102 learns, and/or refines, a representation of one or more of the nodes of the graph 104. When a new data point 116 is added to the graph 104, a deduplication module 118 may determine whether or not the new data point 116 is duplicative of a node already in the graph 104. This determination may be aided by the refinement information provided by the GNN 102. That is, by providing improved resolution of nodes in the graph 104, the GNN 102 may enable a determination as to whether or not any node is a duplicate of another node.

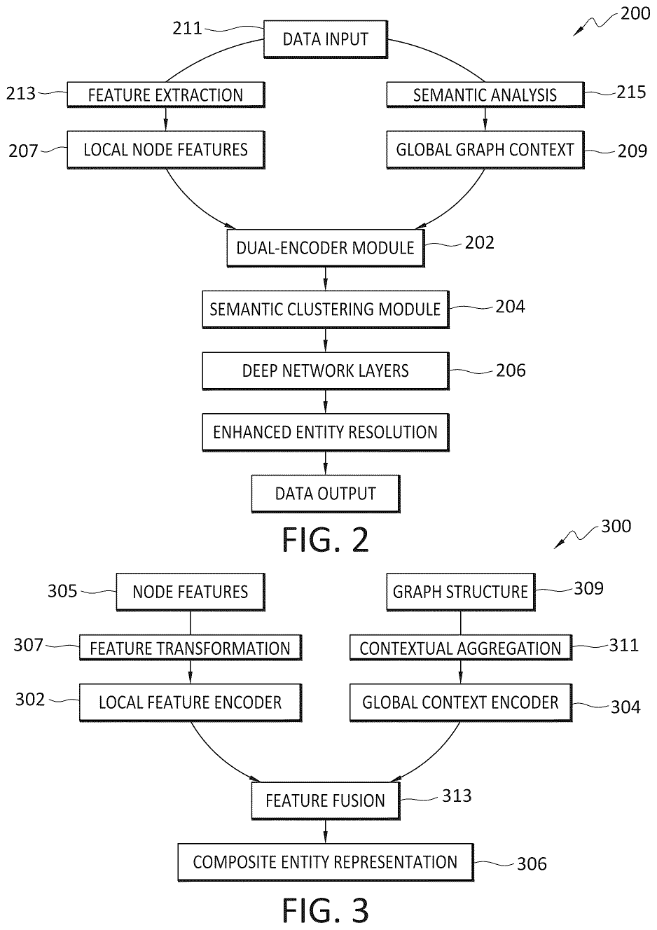

With attention now to FIG. 2, an embodiment comprises a framework that enhances entity resolution across large-scale databases. As shown in the architecture 200 disclosed in FIG. 2, the solution integrates three components, namely, (1) a dual-encoder architecture 202, (2) a semantic clustering module 204, and (3) deep network layers 206, each contributing to deal with challenges identified in disclosed herein.

### D.1.1 Dual-Encoder GNN Architecture

As shown in the example of FIG. 2, the architecture 200 employs a dual-encoder structure in a dual-encoder module 202, where one encoder processes individual data points, and the second encoder processes the aggregated information from neighboring nodes in the graph. This architecture thus enables a comprehensive representation that captures both the local features 207 of individual nodes and the global context 209 provided by the connections between the nodes. As shown in FIG. 2, the local node features 207 may be obtained from an input graph 211 by way of a feature extraction process 213, and the global context 209 information obtained by way of a semantic analysis 215.

### D.1.2 Semantic Clustering Integration

Prior to GNN processing using the deep network layers 206, an embodiment may implement semantic clustering by the semantic clustering module 204 to group nodes based on semantic similarity. This semantic clustering may enhance the ability of the GNN to recognize entities with shared meanings, despite their respective varied representations. The semantic clusters serve as input for the deep network layer 206 of the GNN, which refines the clusters by learning from the graph topology and node features.

### D.1.3 Deep Network Layers

To capture complex patterns and relationships in a graph, an embodiment may increase the depth of a GNN. In particular, additional deep network layers enable the GNN to learn higher-order interactions between nodes, which may be helpful in distinguishing, or resolving, between similar, but distinct, entities of the graph.

### D.2 Detailed Discussion

### D.2.1 Dual-Encoder Architecture

An example embodiment of a dual-encoder architecture 300 is disclosed in FIG. 3. The dual-encoder architecture 300 may operate to enhance a feature extraction process and semantic analysis process (see references 213 and 215 in FIG. 2) by simultaneously capturing both local node features and global graph context. This dual approach may help to ensure a comprehensive representation of each entity in a graph, facilitating more accurate comparisons and resolutions as between entities. The dual-encoder architecture 300 may be implemented as/in a module, such as the dual-encoder module 202 disclosed in FIG. 2.

In an embodiment, the dual-encoder architecture 300 comprises two separate encoder, namely, a local feature encoder 302, and a global context encoder 304. Each of the encoders 302 and 304 is configured, and operates, to process different aspects of the graph data.

Local feature encoder 302: Utilizes node-specific data 305 to learn local representations. This encoder applies a series of transformation layers 307 to the initial node features 305, which can be mathematically represented as:

$${h}_{i}^{( l + 1 )} = σ ( {\sum }_{j ∈ 𝒩 ( i )} \frac{1}{{c}_{ij}} {W}^{( l )} {h}_{j}^{( l )} + {b}^{( l )} ) where {h}_{i}^{( l + 1 )}$$

is the feature vector of node i at layer l, N(i) denotes the neighbors of node i, cᵢⱼ is the normalization constant, W^{(l)} and b^{(l)} are the weight matrix and bias vector for layer l, respectively, and σ is the activation function.

Global Context Encoder 304: Extracts and aggregates global information from the graph structure 309 to capture broader contextual dependencies in a contextual aggregation process 311. This encoder uses a different set of graph neural network layers to embed the structural context of the entire graph:

$${H}^{( l + 1 )} = σ ( {D}^{- 1 / 2} {AD}^{- 1 / 2} {H}^{( l )} {W}^{( l )} )$$

where A is the adjacency matrix of the graph, D is the diagonal degree matrix of A, and H^{(l)} is the matrix of node features at layer l. This architecture enables a nuanced understanding of both local and global data aspects, which is useful in differentiating between similar entities in large datasets.

As shown in FIG. 3, the respective outputs of the local feature encoder 302 and the global context encoder 304 may be joined in a feature fusion process 313 to generate a composite entity representation 306, that is, a representation of the graph and its nodes and edges.

### D.2.2 Semantic Clustering

In an embodiment, and as discussed above in connection with FIG. 2, semantic clustering is implemented as a preprocessing step to enrich a graph structure before the graph structure is processed by the GNN. This method leverages semantic similarities between entities to cluster them, thereby enhancing the initial graph with more informative edges that reflect these semantic relationships.

In one embodiment, the semantic clustering module (see reference 204 in FIG. 2) operates by computing similarity scores between nodes based on their initial features and any available metadata. The similarity score between two nodes i and j of a graph can be defined as:

$$s ( i , j ) cosine ( {v}_{i} , {v}_{j} )$$

where vᵢ and vⱼ are the feature vectors of nodes i and j, respectively. Nodes with similarity scores above a predefined threshold are linked together, forming clusters (see reference 110 in FIG. 1). This clustering is represented mathematically by the modified adjacency matrix A′:

$${A}_{ij}^{′} = \{ \begin{matrix}1 & if s ( i , j ) \geq θ \\ 0 & otherwise\end{matrix}$$

where θ is the similarity threshold. This preprocessing enriches the graph by highlighting non-obvious relationships between entities, which aids the GNN in detecting nuanced entity similarities during resolution tasks, effectively enhancing the accuracy of the system.

### D.2.3 Deep Network Layers

To handle the intricacies of large-scale entity resolution, one embodiment employs a deep network architecture that extends beyond traditional GNNs by incorporating advanced learning techniques and deeper integration with other machine learning paradigms. In an embodiment, a network architecture is built on a multi-layer GNN framework that utilizes specialized layer designs to enhance learning capabilities and adapt to the complexity of the graph data. Some example features of an embodiment of such a network architecture include:

1. Residual Connections: To combat the vanishing gradient problem often encountered in deep networks, an embodiment may incorporate residual connections that allow gradients to flow through the network directly, enhancing training stability and convergence. This is represented by:

$${h}_{i}^{( l + 1 )} = σ ( {W}^{( l )} {h}_{i}^{( l )} {\sum }_{j ∈ 𝒩 ( i )} \frac{1}{{c}_{ij}} {W}^{( l )} {h}_{j}^{( l )} + {B}^{( l )} ) where {h}_{i}^{( l )}$$

2. Attention Mechanisms: An embodiment may integrate graph attention layers that enable the model to focus on the most informative parts of the graph dynamically. This is especially useful for entity resolution where certain connections may be more relevant than others. In an embodiment, the attention coefficients may be computed as:

$${α}_{ij} = \frac{exp ( LeakyReLU ( {a}^{T} [ {Wh}_{i} ‖ {Wh}_{j} ] ) )}{{\sum }_{k ∈ 𝒩 ( i )} exp ( LeakyReLU ( {a}^{T} [ {Wh}_{i} ‖ {Wh}_{k} ] ) )}$$

where a is a learnable parameter vector, ∥ denotes concatenation, and αᵢⱼ represents the attention coefficient between nodes i and j.

In an embodiment, enhancements such as residual connections, and attention mechanisms, not only address the challenges of depth in GNNs but also provide a more adaptable and robust framework for capturing complex entity relationships. Thus, an embodiment may significantly improve the efficacy and accuracy of entity resolution in dynamic and large-scale environments.

### D.2.4 Further Discussion

As disclosed herein, one or more embodiments may make various contributions to the field of entity resolution within large-scale databases, significantly advancing previous methods through the integration of graph neural network technologies and machine learning techniques. Particularly, embodiments may comprise various useful features and aspects, although no embodiment is required to possess any of such features or aspects. One embodiment comprises a dual-encoder architecture that uniquely combines local node features with global graph context, enabling a more nuanced comparison of data points. An embodiment may provide the integration of semantic clustering prior to GNN processing, which leverages semantic similarities to enrich the graph structure and improve entity recognition. An embodiment may employ deeper network layers to capture complex patterns and relationships, allowing for a more refined differentiation between similar entities of a graph. An embodiment may provide a significant reduction in data redundancy, leading to cost savings and increased operational efficiency.

In more detail, an embodiment may comprise a dual-encoder architecture framework that combines local node features with global graph context. Unlike conventional approaches, which typically focus on either local or global features, an embodiment may capture and integrate both perspectives simultaneously, enhancing the accuracy and robustness of entity resolution.

An embodiment may implement semantic clustering as preprocessing prior to GNN processing, by integrating semantic clustering to enrich the graph structure. This preprocessing operation utilizes semantic similarities to group entities, which is not typically employed in traditional GNN workflows. Thus, an embodiment may generate a more informative graph structure, thereby improving the ability of the GNN to recognize nuanced similarities between entities.

An embodiment may implement and employ deep network layers so as to extend the depth of GNNs through the introduction of residual connections and attention mechanisms. These enhancements are specifically designed to address the challenges of training deeper GNNs, such as vanishing gradients and the need for selective focus on relevant parts of the graph.

An embodiment may provide real-time adaptability. A framework according to one embodiment may be capable of real-time data processing, adapting to the dynamic nature of data flows in large-scale databases. This is achieved through the efficient configuration of network layers and the scalability of the architecture.

Thus, this disclosure provides, among other things, a dual-encoder Graph Neural Network (GNN) framework configured to enhance entity resolution in large-scale databases. An approach according to one embodiment integrates local node features with global graph context, leverages semantic clustering as a preprocessing step, and employs deep network layers with residual connections and attention mechanisms. These components collectively address the significant challenges of scalability, accuracy, and real-time processing in data management systems.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.

Embodiment 1. A method for improving resolution of entities represented by nodes of a graph, comprising: receiving, by a dual-encoder module, local node features of nodes of a graph that comprises data, and global structure information of the graph; performing, by a local feature encoder of the dual-encoder module, a feature transformation process on the local node features; performing, by a global context encoder of the dual-encoder module, a context aggregation process on the global graph structure information; and fusing an output of the feature transformation process with an output of the global context aggregation process to generate a composite entity representation of the graph.

Embodiment 2. The method as recited in any preceding embodiment, wherein the composite entity representation of the graph is output to a semantic clustering process which generates semantic clusters that group nodes of the graph based on their semantic similarity.

Embodiment 3. The method as recited in embodiment 2, wherein the semantic clustering process comprises computing similarity scores between nodes based on initial features of the nodes, and based on any available metadata.

Embodiment 4. The method as recited in embodiment 2, wherein the semantic clustering process identifies non-obvious relationships between entities respectively represented by the nodes.

Embodiment 5. The method as recited in embodiment 2, wherein the semantic clustering process improves, relative to a process that does not employ the semantic clustering process, recognition of entities respectively represented by the nodes.

Embodiment 6. The method as recited in embodiment 2, wherein the semantic clustering process enables identification of duplicate data in the graph.

Embodiment 7. The method as recited in embodiment 2, wherein the processes performed by the dual-encoder module are performed in real time as data comes into the graph.

Embodiment 8. The method as recited in embodiment 2, wherein after the semantic clustering process is completed, the semantic clusters are provided as an input to a GNN (graph neural network).

Embodiment 9. The method as recited in embodiment 8, wherein the GNN processes the semantic clusters through the use of residual connections and attention mechanisms.

Embodiment 10. The method as recited in embodiment 9, wherein use of the residual connections and the attention mechanisms enables elimination of vanishing gradients in the graph, and provides selective focus on specified parts of the graph.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

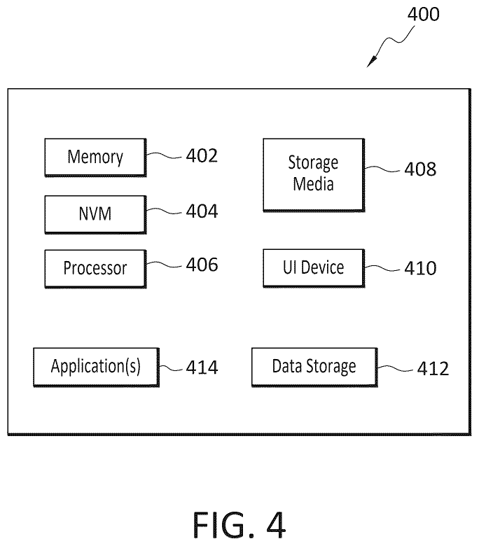

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for improving resolution of entities represented by nodes of a graph, comprising:
receiving, by a dual-encoder module, local node features of nodes of a graph that comprises data, and global structure information of the graph;
performing, by a local feature encoder of the dual-encoder module, a feature transformation process on the local node features;
performing, by a global context encoder of the dual-encoder module, a context aggregation process on the global graph structure information; and
fusing an output of the feature transformation process with an output of the global context aggregation process to generate a composite entity representation of the graph.

2. The method as recited in claim 1, wherein the composite entity representation of the graph is output to a semantic clustering process which generates semantic clusters that group nodes of the graph based on their semantic similarity.

3. The method as recited in claim 2, wherein the semantic clustering process comprises computing similarity scores between nodes based on initial features of the nodes, and based on any available metadata.

4. The method as recited in claim 2, wherein the semantic clustering process identifies non-obvious relationships between entities respectively represented by the nodes.

5. The method as recited in claim 2, wherein the semantic clustering process improves, relative to a process that does not employ the semantic clustering process, recognition of entities respectively represented by the nodes.

6. The method as recited in claim 2, wherein the semantic clustering process enables identification of duplicate data in the graph.

7. The method as recited in claim 2, wherein the processes performed by the dual-encoder module are performed in real time as data comes into the graph.

8. The method as recited in claim 2, wherein after the semantic clustering process is completed, the semantic clusters are provided as an input to a GNN (graph neural network).

9. The method as recited in claim 8, wherein the GNN processes the semantic clusters through the use of residual connections and attention mechanisms.

10. The method as recited in claim 9, wherein use of the residual connections and the attention mechanisms enables elimination of vanishing gradients in the graph, and provides selective focus on specified parts of the graph.

11. A non-transitory storage medium having stored therein instructions that are executable by one or more hardware processors to perform operations comprising:
receiving, by a dual-encoder module, local node features of nodes of a graph that comprises data, and global structure information of the graph;
performing, by a local feature encoder of the dual-encoder module, a feature transformation process on the local node features;
performing, by a global context encoder of the dual-encoder module, a context aggregation process on the global graph structure information; and
fusing an output of the feature transformation process with an output of the global context aggregation process to generate a composite entity representation of the graph.

12. The non-transitory storage medium as recited in claim 11, wherein the composite entity representation of the graph is output to a semantic clustering process which generates semantic clusters that group nodes of the graph based on their semantic similarity.

13. The non-transitory storage medium as recited in claim 12, wherein the semantic clustering process comprises computing similarity scores between nodes based on initial features of the nodes, and based on any available metadata.

14. The non-transitory storage medium as recited in claim 12, wherein the semantic clustering process identifies non-obvious relationships between entities respectively represented by the nodes.

15. The non-transitory storage medium as recited in claim 12, wherein the semantic clustering process improves, relative to a process that does not employ the semantic clustering process, recognition of entities respectively represented by the nodes.

16. The non-transitory storage medium as recited in claim 12, wherein the semantic clustering process enables identification of duplicate data in the graph.

17. The non-transitory storage medium as recited in claim 12, wherein the processes performed by the dual-encoder module are performed in real time as data comes into the graph.

18. The non-transitory storage medium as recited in claim 12, wherein after the semantic clustering process is completed, the semantic clusters are provided as an input to a GNN (graph neural network).

19. The non-transitory storage medium as recited in claim 18, wherein the GNN processes the semantic clusters through the use of residual connections and attention mechanisms.

20. The non-transitory storage medium as recited in claim 19, wherein use of the residual connections and the attention mechanisms enables elimination of vanishing gradients in the graph, and provides selective focus on specified parts of the graph.
